(19) United States
(12) Patent Application Publication
(10) Pub. No.: US 2018/0038568 A1
(43) Pub. Date: Feb. 8, 2018

(54) VEHICULAR LIGHTING APPARATUS

(71) Applicant: TOYOTA JIDOSHA KABUSHIKI KAISHA, Toyota-shi (JP)

(72) Inventor: Tomonari SAWADA, Nagoya-shi (JP)

(73) Assignee: TOYOTA JIDOSHA KABUSHIKI KAISHA, Toyota-shi (JP)

(21) Appl. No.: 15/631,999

(22) Filed: Jun. 23, 2017

(30) Foreign Application Priority Data
Aug. 4, 2016 (JP) 2016-153589

(51) Int. Cl. F21S 8/10

(52) U.S. Cl. CPC F21S 48/171

(57) ABSTRACT

While an own vehicle is traveling through the tunnel, a lighting ECU detects a side-wall position direction indicating a direction of a side wall of a tunnel T, which is adjacent to a lane in which the own vehicle is traveling, with respect to the own vehicle. The lighting ECU turns ON one of cornering lights respectively provided on a left side and a right side of the own vehicle, which is provided on the side-wall position direction.

### BACKGROUND OF THE INVENTION

### Field of the Invention

The present invention relates to a vehicular lighting apparatus configured to radiate light ahead of an own vehicle.

### Description of the Related Art

Hitherto, for example, as proposed in Japanese Patent Application Laid-open No. 2007-238072, the following controller has been known. Specifically, the controller is configured to calculate a target light distribution direction of a headlamp based on a steering angle detected by a steering angle sensor and to control an optical axis of the headlamp so that a light distribution direction of the headlamp matches with the calculated target light distribution direction.

In general, the headlamp is intended to irradiate an area ahead of an own vehicle, and illuminates neither a right side nor a left side within a field of view of a driver. Therefore, while the vehicle is traveling through a tunnel, it is difficult for the driver to perceive a distance between a side wall of the tunnel and the own vehicle, and hence the driver sometimes has an oppressive feeling due to the side walls of the tunnel. Therefore, the driver sometimes feels anxiety and fear of traveling through the tunnel. Even with the controller proposed in Japanese Patent Application Laid-open No. 2007-238072, the above-mentioned problem cannot be solved while the own vehicle is traveling straight ahead through the tunnel.

The present invention has been made to solve the problem described above, and has an object to reduce anxiety of a driver during travel through a tunnel.

### SUMMARY OF THE INVENTION

In order to achieve the above-mentioned object, a vehicular lighting apparatus according to one embodiment of the present invention has a feature in that the vehicular lighting apparatus includes:

an irradiator including:
a main irradiation unit (20L, 20R, 121L, 121R) for radiating light ahead of an own vehicle; and
a support irradiation unit (30L, 30R, 122L, 122R) for supporting the main irradiation unit in the radiation of the light;

side-wall position direction detecting means (10, 110, 40, 50, Step S14) for detecting a side-wall position direction indicating a relative position of a side wall of a tunnel, which is adjacent to a lane in which the own vehicle is traveling, with respect to the own vehicle while the own vehicle is traveling through the tunnel; and

side-wall irradiation control means (10, 110, Step S16, Step S17, Step S18) for setting, when the side wall of the tunnel is positioned adjacent to the lane in which the own vehicle is traveling, a direction of the radiation of the light by the support irradiation unit, based on the side-wall position direction, so that an irradiation area irradiated by the irradiator becomes larger on a side of the side-wall position direction than an irradiation area irradiated by the main irradiation unit and controlling the support irradiation unit to radiate the light.

The vehicular lighting apparatus according to the one embodiment of the present invention includes the irradiator including the main irradiation unit for radiating light ahead of the own vehicle and the support irradiation unit for supporting the main irradiation unit in the radiation of the light. The support irradiation unit is configured to support the main irradiation unit in the radiation of the light by radiating the light to an area that cannot be irradiated by the main irradiation unit so as to enlarge the irradiation area irradiated by the irradiator.

During travel through the tunnel, it is difficult for a driver to perceive a distance between the side wall of the tunnel and the own vehicle. Therefore, in the one embodiment of the present invention, the side-wall position direction detecting means and the side-wall irradiation control means are provided. The side-wall position direction detecting means detects the side-wall position direction indicating the position direction (a right direction or a left direction) of the side wall of the tunnel, which is adjacent to the lane in which the own vehicle is traveling, while the own vehicle is traveling through the tunnel. The term “side wall of the tunnel is positioned adjacent to the lane in which the own vehicle is traveling” means that another lane does not exist between the lane in which the own vehicle is traveling and the side wall of the tunnel.

When the side wall of the tunnel is positioned adjacent to the lane in which the own vehicle is traveling, the side-wall irradiation control means sets the direction of radiation from the support irradiation unit based on the side-wall position direction to control the support irradiation unit to radiate the light so that the irradiation area irradiated by the irradiator becomes larger on a side of the side-wall position direction than the irradiation area irradiated only by the main irradiation unit.

For example, when the side wall of the tunnel is positioned on the left of the lane in which the own vehicle is traveling, the side-wall irradiation control means sets the direction of radiation from the support irradiation unit and controls the support irradiation unit to radiate the light so that a left part of the irradiation area irradiated by the irradiator becomes larger than the irradiation area irradiated only by the main irradiation unit. In this manner, a left side wall of the tunnel, which falls within a field of view of the driver, is illuminated. Similarly, for example, when the side wall of the tunnel is positioned on the right of the lane in which the own vehicle is traveling, the side-wall irradiation control means sets the direction of radiation from the support irradiation unit and controls the support irradiation unit to radiate the light so that a right part of the irradiation area irradiated by the irradiator becomes larger than the irradiation area irradiated only by the main irradiation unit. In this manner, a right side wall of the tunnel, which falls within the field of view of the driver, is illuminated.

As a result, the driver can easily perceive the distance between the side wall of the tunnel and the own vehicle, and therefore is less likely to have an oppressive feeling due to the side walls of the tunnel. Therefore, according to the one embodiment of the present invention, anxiety given to the driver during the travel through the tunnel can be reduced. Further, the direction of radiation from the support irradiation unit is set based on the side-wall position direction. Thus, the irradiation area does not expand toward another lane adjacent to the lane in which the own vehicle is traveling. Therefore, a driver of another vehicle can be prevented from mistakenly perceiving a lane change by the own vehicle or having discomfort.

A feature of a vehicular lighting apparatus according to one embodiment of the present invention resides in that:

the support irradiation unit includes a variable light distribution light (122L, 122R) capable of controlling the radiation of the light for each of a plurality of light distribution areas obtained by dividing an irradiation area ahead of the own vehicle in a vehicle width direction; and

the side-wall irradiation control means (110) is configured to select a light distribution area positioned on the side-wall position direction from the plurality of divided light distribution areas and control the variable light distribution light so that the selected light distribution area is irradiated with the light.

In the one embodiment of the present invention, the variable light distribution light is used as the support irradiation unit. The variable light distribution light is capable of controlling the radiation of the light for each of a plurality of light distribution areas obtained by dividing an irradiation area ahead of the own vehicle in a vehicle width direction. During travel through the tunnel, the side-wall irradiation control means selects the light distribution area on the side-wall position direction from the plurality of divided light distribution areas and control the variable light distribution light so that the selected light distribution area is irradiated with the light. Therefore, the side wall of the tunnel, which is adjacent to the lane in which the own vehicle is traveling, can be irradiated with the light by the support irradiation unit.

A feature of a vehicular lighting apparatus according to one embodiment of the present invention resides in that:

the main irradiation unit includes a headlight for low beam (121L, 121R), for radiating the light ahead of the own vehicle; and

the support irradiation unit includes a headlight for high beam (122L, 122R), which uses the variable light distribution light.

In the one embodiment of the present invention, the variable light distribution headlight for high beam is used as the support irradiation unit. Therefore, when light distribution by the variable light distribution light is controlled by the side-wall irradiation control means, the irradiation area irradiated by the irradiator expands to an upper side and a far side on the side-wall position direction as compared to an irradiation area irradiated by the headlight for low beam. As a result, the side wall of the tunnel can be illuminated.

Therefore, according to the one embodiment of the present invention, a dedicated support irradiation unit for irradiating the side walls of the tunnel is not required to be provided. Thus, the irradiation of the side walls of the tunnel can be achieved at low cost. When the headlights for high beam are provided to both a left side and a right side of a front end of the own vehicle, the side-wall irradiation control means only needs to select the headlight for high beam provided on the side-wall position direction so that the selected headlight for high beam is controlled to irradiate one of the plurality of light distribution areas, which is on the side-wall position direction, with light. Alternatively, both the left headlight for high beam and the right headlight for high beam may be controlled so as to irradiate the light distribution area, which is positioned on the side-wall position direction, with the light.

A feature of a vehicular lighting apparatus according to one embodiment of the present invention resides in that:

the main irradiation unit includes a headlight (20L, 20R) for radiating the light ahead of the own vehicle;

the support irradiation unit includes a left support light (30L), which is provided to a left side of the own vehicle, for radiating light to a diagonally left side ahead of the own vehicle, and a right support light (30R), which is provided to a right side of the own vehicle, for radiating light to a diagonally right side ahead of the own vehicle; and

the side-wall irradiation control means (10) is configured to select and turn ON one of the left support light and the right support light, which is provided on the side-wall position direction.

In the one embodiment of the present invention, the left support light and the right support light are provided as the support irradiation unit. The left support light is provided to the left side of the own vehicle and is configured to radiate light to a diagonally left area ahead of the own vehicle. The right support light is provided to the right side of the own vehicle and is configured to radiate light to a diagonally right area ahead of the own vehicle. During travel through the tunnel, the side-wall irradiation control means selects and turns ON one of the support lights, which is provided on the side-wall position direction. Specifically, when the side-wall position direction is the left, the left support light is selected to be turned ON. When the side-wall position direction is the right, the right support light is selected to be turned ON. Therefore, the side walls of the tunnel can be irradiated with light.

A feature of a vehicular lighting apparatus according to one embodiment of the present invention resides in that:

the left support light includes a left cornering light (30L) to be turned ON when the own vehicle is steered to left; and

the right support light includes a right cornering light (30R) to be turned ON when the own vehicle is steered to right.

In the one embodiment of the present invention, the cornering lights are used as the support irradiation unit. The cornering light is configured to radiate light diagonally forward in a steering direction of the own vehicle when the own vehicle is steered so that visibility during right turn or left turn at an intersection or the like is improved. The cornering light is also referred to as “side light” in some cases. For example, when the steering direction is a left-hand direction, the cornering light provided to the left side of the own vehicle radiates light to the diagonally left area ahead of the own vehicle. Further, when the steering direction is a right-hand direction, the cornering light provided to the right side of the own vehicle radiates light to the diagonally right area ahead of the own vehicle. The cornering lights are turned ON only when a predetermined steering operation is performed. In the one embodiment of the present invention, the side-wall irradiation control means selects and turns ON the cornering light provided on the side-wall position direction during the travel through the tunnel.

Therefore, the side walls of the tunnel can be irradiated by using the cornering lights provided to the own vehicle. As a result, according to the one embodiment of the present invention, a dedicated support irradiation unit for irradiation of the side walls of the tunnel is not required to be provided. Thus, the irradiation of the side walls of the tunnel can be achieved at low cost.

A feature of a vehicular lighting apparatus according to one embodiment of the present invention resides in that:

the vehicular lighting apparatus further includes lane change means (Step S19) for detecting a lane change operation performed by a driver while the own vehicle is traveling through the tunnel; and

the side-wall irradiation control means is configured to, when the lane change operation is detected, turn OFF the one of the left support light and the right support light, which is provided on the side-wall position direction, and turn ON another of the left support light and the right support light provided on a direction of which the own vehicle is making a lane change (Step S20).

In the one embodiment of the present invention, the lane change means detects the lane change operation performed by the driver while the own vehicle is traveling through the tunnel. For example, the lane change means detects the lane change operation performed by the driver based on an operation of a steering wheel or an operation of a turn signal. When the lane change operation is detected, the side-wall irradiation control means turns OFF one of the support lights, which is provided on the side-wall position direction, and turns ON another of the support lights, which is provided on the direction of which the own vehicle is making a lane change. Therefore, visibility of the lane into which the own vehicle is making a lane change can be improved.

A feature of a vehicular lighting apparatus according to one embodiment of the present invention resides in that:

the vehicular lighting apparatus further includes another vehicle detecting means (40′) for detecting another vehicle being present in a periphery of the own vehicle; and

the side-wall irradiation control means is configured to turn ON both the left support light and the right support light (Step S22) when the another vehicle is not detected in the periphery of the own vehicle (No in Step S21).

When the irradiation area is expanded toward another lane adjacent to the lane in which the own vehicle is traveling, discomfort is undesirably given to a driver of another vehicle. Under a condition in which another vehicle is not present in the periphery of the own vehicle, the above-mentioned problem does not occur. Thus, in the one embodiment of the present invention, the another vehicle detecting means is provided. When another vehicle is not detected by the another vehicle detecting means in the periphery of the own vehicle, the side-wall irradiation control means turns ON both the left support light and the right support light. Therefore, a lateral area diagonally ahead of the own vehicle on each of the left side and the right side is illuminated. As a result, visibility on both the left side and the right side within the field of view of the driver is improved. As a result, the own vehicle can travel further safely. Further, a security feeling can be given to the driver. In addition, the discomfort is not given to the driver of the another vehicle.

A feature of a vehicular lighting apparatus according to one embodiment of the present invention resides in that the side-wall position direction detecting means is configured to specify a lane of a plurality of lanes on a road, in which the own vehicle is traveling, and to detect the side-wall position direction based on the specified lane (Step S14).

When the own vehicle travels through the tunnel, the side-wall position direction of the side wall of the tunnel can be estimated when the lane in which the own vehicle is traveling is specified. Therefore, the side-wall position direction detecting means specifies the lane in which the own vehicle is traveling from the plurality of lanes of the road and detects the side-wall position direction based on the specified lane. For example, in a case where a road inside the tunnel has three lanes, when the lane in which the own vehicle is traveling is a left lane, the side-wall position direction in the tunnel is on the left. When the lane in which the own vehicle is traveling is a right lane, the side-wall relative position in the tunnel is on the right. When the lane in which the own vehicle is traveling is a central lane, the side walls are not adjacent to the lane in which the own vehicle is traveling. The lane as described above can be specified by using, for example, a navigation device or an onboard camera.

In the above description, in order to facilitate the understanding of the invention, reference symbols used in embodiments of the present invention are enclosed in parentheses and are assigned to each of the constituent features of the invention corresponding to the embodiments. However, each of the constituent features of the invention is not limited to the embodiments as defined by the reference symbols.

### BRIEF DESCRIPTION OF THE DRAWINGS

FIG. 1 is a schematic configuration diagram of a vehicular lighting apparatus according to a first embodiment of the present invention.

FIG. 2 is a front view of a vehicle for illustrating an arrangement of headlights, cornering lights, and a camera device.

FIG. 3 is a plan view for comparison of irradiation areas irradiated by the cornering lights with an irradiation area irradiated by the headlights.

FIG. 4 is a flowchart for illustrating a tunnel irradiation assist control routine according to the first embodiment.

FIG. 5A, FIG. 5B, and FIG. 5C are plan views for illustrating irradiation areas in a tunnel according to the first embodiment.

FIG. 6 is a flowchart for illustrating a tunnel irradiation assist control routine (Modification Example 1) according to the first embodiment.

FIG. 7 is a flowchart for illustrating a tunnel irradiation assist control routine (Modification Example 2) according to the first embodiment.

FIG. 8 is a schematic configuration diagram for illustrating a vehicular lighting apparatus according to a second embodiment of the present invention.

FIG. 9 is an explanatory view for illustrating high beam light distribution areas.

FIG. 10A, FIG. 10B, and FIG. 10C are plan views for illustrating irradiation areas in the tunnel according to the second embodiment.

### DESCRIPTION OF THE PREFERRED EMBODIMENTS

Now, description is made of a vehicular lighting apparatus according to embodiments of the present invention with reference to the accompanying drawings.

### First Embodiment

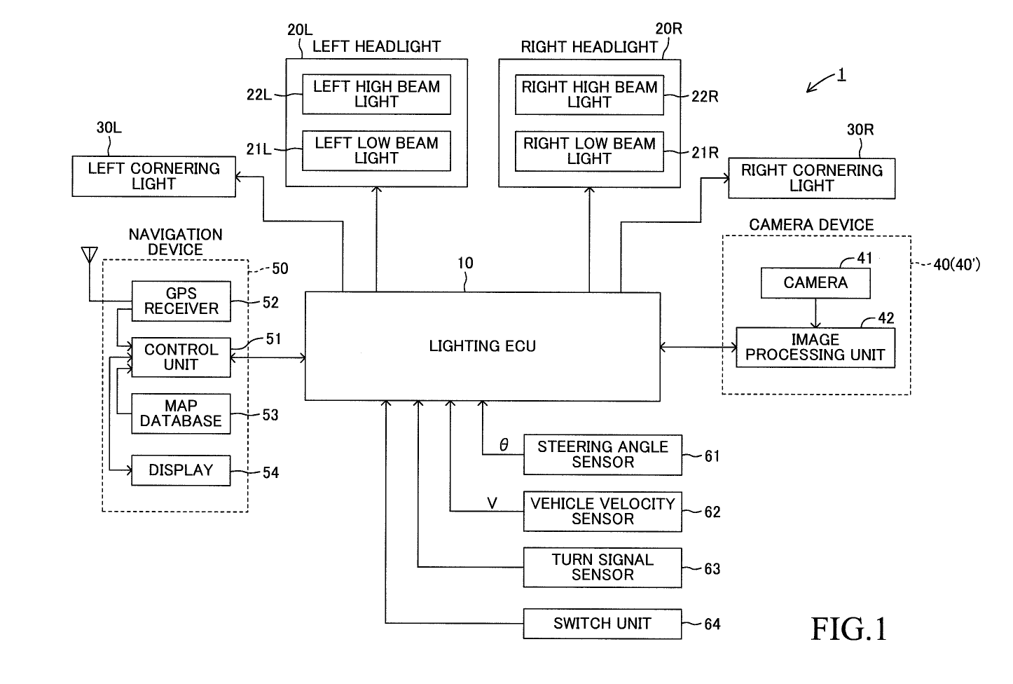

In FIG. 1, a schematic configuration of a vehicular lighting apparatus 1 according to a first embodiment of the present invention is illustrated. The vehicular lighting apparatus 1 is mounted in a vehicle (hereinafter also referred to as “own vehicle” for distinction from other vehicles), and includes a lighting ECU 10, a left headlight 20L, a right headlight 20R, a left cornering light 30L, a right cornering light 30R, a camera device 40, a navigation device 50, a steering angle sensor 61, a vehicle velocity sensor 62, a turn signal sensor 63, and a switch unit 64.

The lighting ECU 10 is an electric control unit including a microcomputer as a main part. In the specification of the present invention, the microcomputer includes a CPU, a ROM, a RAM, a non-volatile memory, and an interface I/F. The CPU achieves various functions by executing an instruction (program, routine) stored in the ROM.

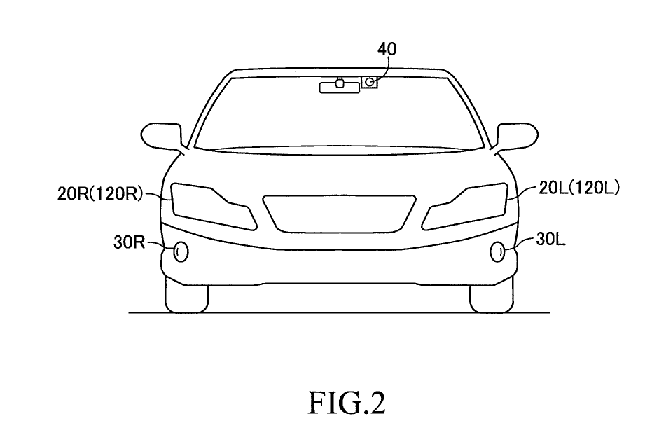

As illustrated in FIG. 2, the left headlight 20L is provided to a left side of a front end (left front corner) of the vehicle, whereas the right headlight 20R is provided to a right side of the front end (right front corner) of the vehicle. The left headlight 20L and the right headlight 20R are provided bilaterally symmetrical, and have the same basic configuration. The left headlight 20L includes a left low beam light 21L and a left high beam light 22L. The right headlight 20R includes a right low beam light 21R and a right high beam light 22R.

When the left headlight 20L and the right headlight 20R are not required to be distinguished from each other, the left headlight 20L and the right headlight 20R are hereinafter referred to collectively as “headlights 20”. Further, when the left low beam light 21L and the right low beam light 21R are not required to be distinguished from each other, the left low beam light 21L and the right low beam light 21R are referred to collectively as “low beam lights 21”. When the left high beam light 22L and the right high beam light 22R are not required to be distinguished from each other, the left high beam light 22L and the right high beam light 22R are referred to collectively as “high beam lights 22”. The low beam lights 21 and the high beam lights 22 are connected to the lighting ECU 10, and are controlled to be turned ON by the lighting ECU 10.

As illustrated in FIG. 2, the left cornering light 30L is provided in the vicinity of the left headlight 20L, specifically, below the left headlight 20L in the first embodiment, whereas the right cornering light 30R is provided in the vicinity of the right headlight 20R, specifically, below the right headlight 20R in the first embodiment. The left cornering light 30L and the right cornering light 30R are provided bilaterally symmetrical, and have the same basic configuration. When the left cornering light 30L and the right cornering light 30R are not required to be distinguished from each other, the left cornering light 30L and the right cornering light 30R are hereinafter referred to collectively as “cornering lights 30”. The cornering lights 30 are connected to the lighting ECU 10, and are controlled to be turned ON independently of each other by the lighting ECU 10.

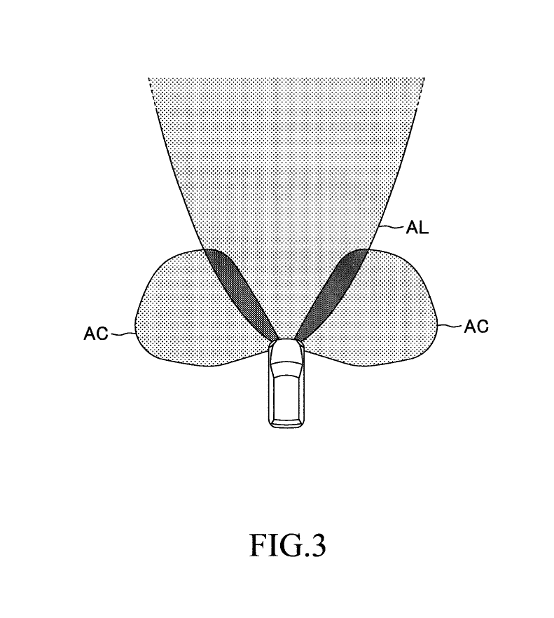

As illustrated in FIG. 3, contrary to the headlights 20, which irradiate an area ahead of the vehicle, the cornering lights 30 irradiate lateral areas diagonally ahead of the vehicle, which contain immediate lateral areas. Specifically, an optical axis direction of the left cornering light 30L and an optical axis direction of the right cornering light 30R are set so that the left cornering light 30L irradiates a left area diagonally ahead of the vehicle, which contains an area positioned on the immediate left of a mounting position of the left cornering light 30L, and the right cornering light 30R irradiates a right area diagonally ahead of the vehicle, which contains an area positioned on the immediate right of a mounting position of the right cornering light 30R. In FIG. 3, a partial area AL of an irradiation area (on the vehicle side) irradiated by the headlights 20 (low beam lights 21) and irradiation areas AC irradiated respectively by the cornering lights 30 are illustrated.

The headlights 20 correspond to a main irradiation unit of the present invention, whereas the cornering lights 30 correspond to an support irradiation unit of the present invention. Therefore, a configuration including the headlights 20 and the cornering lights 30 corresponds to an irradiator of the present invention. Further, the left cornering light 30L corresponds to a left support light of the present invention, whereas the right cornering light 30R corresponds to a right support light of the present invention.

As illustrated in FIG. 2, the camera device 40 is provided at such a position as to be capable of photographing ahead of the own vehicle from a vehicle interior side of a windshield. The camera device 40 includes a camera 41 and an image processing unit 42. The camera 41 is configured to transmit image data obtained by photographing a sight ahead of the own vehicle to the image processing unit 42. The image processing unit 42 is configured to detect a preceding vehicle, an oncoming vehicle, and a pedestrian based on the image data photographed by the camera 41.

Further, the image processing unit 42 also has a function of detecting an entrance of a tunnel that is present ahead of the own vehicle based on the image data and a function of perceiving a plurality of lane markers such as white lines formed on a road (hereinafter referred to simply as “white lines”) so as to detect a lane in which the own vehicle is traveling based on the perceived white lines. The image processing unit 42 supplies the lighting ECU 10 with information relating to the detected preceding vehicle, oncoming vehicle, pedestrian, entrance of the tunnel, and lanes. The information supplied by the image processing unit 42 to the lighting ECU 10 is hereinafter referred to as “camera information”.

The navigation device 50 includes a control unit 51, a GPS receiver 52, a map database 53, a touch panel-type display 54, and the like. The control unit 51 is configured to provide route guidance based on various types of information. The GPS receiver 52 is configured to receive a GPS signal for detecting a current position of the own vehicle. The map database 53 is configured to store map information and the like. The touch panel-type display 54 is a human machine interface. The control unit 51 is configured to specify the position of the own vehicle at the current time based on the GPS signal and perform various types of calculation processing based on the position of the own vehicle and the map information stored in the map database 53 so as to provide the route guidance by using the display 54.

The map information stored in the map database 53 contains road information. The road information contains lane information indicative of the number of lanes for each interval of the road and tunnel information indicative of a position of the tunnel. The control unit 51 supplies the lighting ECU 10 with the position information of the own vehicle detected by the GPS receiver 52 and the road information relating to the road on which the own vehicle is traveling. The information supplied by the control unit 51 to the lighting ECU 10 is hereinafter referred to as “navigation information”.

The steering angle sensor 61 detects a steering angle θ of the own vehicle to supply a signal indicative of the steering angle θ to the lighting ECU 10.

The vehicle velocity sensor 62 detects a vehicle velocity (vehicle-body velocity) of the own vehicle to supply a signal indicative of a vehicle velocity V to the lighting ECU 10. Wheel-velocity sensors configured to detect wheel velocities of four wheels of the own vehicle may be used in place of the vehicle velocity sensor 62.

The turn signal sensor 63 detects a direction of actuation of a turn signal lever operated by the driver to supply a turn-signal signal being a detection signal of the turn signal sensor 63 to the lighting ECU 10.

The switch unit 64 includes a lighting switch configured to switch ON/OFF of the headlights 20, a Hi/Lo selector switch configured to switch between a high-beam light distribution and a low-beam light distribution, a cornering light assist select switch configured to select whether or not to automatically turn ON the cornering lights 30, and a tunnel irradiation assist select switch configured to select whether or not to carry out tunnel irradiation assist control described later. The switch unit 64 supplies information set by a setting operation performed by the driver to the lighting ECU 10.

The lighting switch may be an automatic selector switch using a signal of an illuminance sensor configured to detect an illuminance in a periphery of the own vehicle. Further, the cornering light assist select switch and the tunnel irradiation assist select switch are not necessarily required to be provided. When the cornering light assist select switch and the tunnel irradiation assist select switch are not provided, automatic turn-ON of the cornering lights and execution of the tunnel irradiation assist control only need to be set constantly.

The tunnel irradiation assist control performed by the lighting ECU 10 is now described. The tunnel irradiation assist control is control for illuminating any one of side walls of a tunnel while the own vehicle is traveling through the tunnel so that the driver can safely drive the vehicle through the tunnel. In the first embodiment, the cornering lights 30 are used to illuminate the side walls of the tunnel.

Now, original functions of the cornering lights 30 are first described. The cornering lights 30 are support lights configured to improve visibility of a pedestrian or an obstacle which is present in a right-turn direction or a left-turn direction when the own vehicle turns right or left at an intersection. The lighting ECU 10 is configured to turn ON the cornering light 30 for the direction in which the own vehicle turns when the lighting of the turn signal or an operation of a steering wheel is detected while the vehicle is traveling with the headlights lit.

For example, when detecting the lighting of the turn signal or the steering angle θ being equal to or larger than 80° under a condition where the vehicle velocity V becomes equal to or lower than 40 km/h in the headlights lit state, the lighting ECU 10 turns ON the cornering light 30 for the direction in which the own vehicle turns. As a result, as illustrated in FIG. 3, the area AC, specifically, only the area AC existing in the turning direction, which cannot be illuminated only by the headlights 20 can be irradiated with light. As a result, safety for right turn and left turn during nighttime is improved.

<Tunnel Irradiation Assist Control Routine>

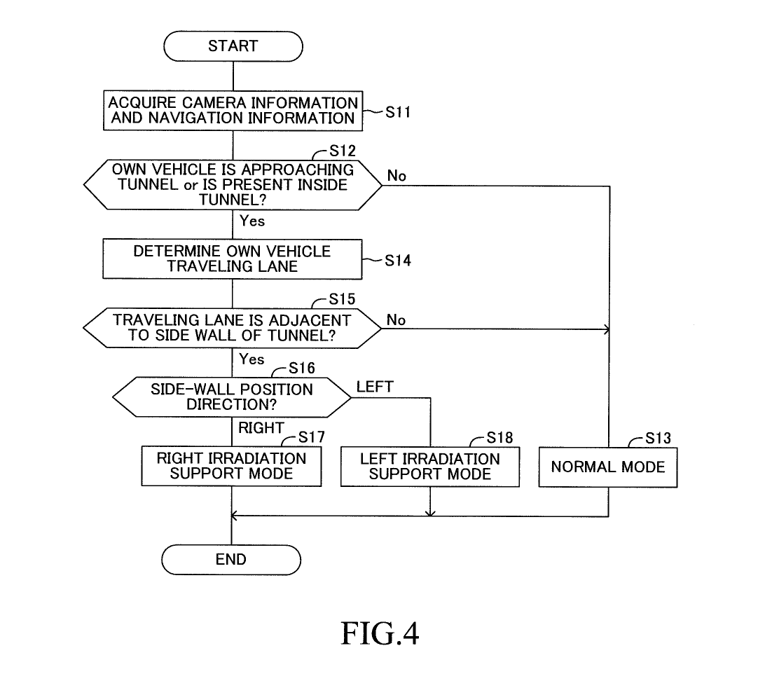

The lighting ECU 10 executes the tunnel irradiation assist control by using the cornering lights 30 when the execution of the tunnel irradiation assist control is selected through the tunnel irradiation assist select switch. In FIG. 4, a tunnel irradiation assist control routine executed by the lighting ECU 10 is illustrated. While an ignition switch is ON, the lighting ECU 10 repeatedly carries out the tunnel irradiation assist control routine in predetermined short calculation periods.

When the tunnel irradiation assist control routine is activated, the lighting ECU 10 acquires the camera information and the navigation information in Step S11. Subsequently, the lighting ECU 10 determines in Step S12 whether or not the own vehicle is approaching a tunnel or the own vehicle is currently present in the tunnel.

For example, the determination of whether or not the own vehicle is approaching the tunnel can be made based on whether or not an entrance of the tunnel, which may also be a tunnel sign has been detected by using the camera device 40. Alternatively, whether or not the tunnel exists in a traveling direction of the own vehicle and whether or not the own vehicle is present within a predetermined distance range before the entrance of the tunnel may be determined by using the navigation device 50.

Further, after the own vehicle enters the tunnel, the position of the own vehicle cannot be detected based on the GPS signal. Thus, it is determined that the own vehicle is traveling through the tunnel until the GPS signal is detected again. Alternatively, a distance from the entrance of the tunnel to an exit of the tunnel (referred to as “tunnel length”) can be obtained from the tunnel information. Thus, whether or not the own vehicle is traveling through the tunnel can be determined based on a traveling distance, which can be calculated by integrating the vehicle velocity V, after the own vehicle enters the tunnel and the tunnel length. Alternatively, whether or not the own vehicle is traveling through the tunnel can be determined by detecting characteristics of a sight inside the tunnel from an image photographed by the camera device 40.

When determining “No” in Step S12, specifically, when the own vehicle is not present in an interval from a position before the entrance of the tunnel to a position of the exit of the tunnel (the interval is referred to as “tunnel interval”,), the lighting ECU 10 sets an irradiation mode to a “normal mode” in Step S13.

The lighting ECU 10 stores three modes being a “normal mode”, a “right irradiation support mode”, and a “left irradiation support mode” as the irradiation modes. The irradiation modes are control modes for the cornering lights 30. In the “normal mode”, as described above, when it is detected that the turn signal is lit or the steering angle θ becomes equal to or larger than 80° under conditions where the vehicle velocity V becomes equal to or lower than 40 km/h under the headlight lit state, the cornering light 30 corresponding to the direction in which the own vehicle turns is turned ON. Therefore, in the “normal mode”, at the right turn or the left turn during nighttime, visibility of a pedestrian or an obstacle present in the right-turn direction or the left-turn direction can be improved.

On the other hand, in the “right irradiation support mode”, the right cornering light 30R is turned ON under the headlight lit state regardless of the steering operation or the turn signal operation performed by the driver. Further, in the “left irradiation support mode”, the left cornering light 30L is turned ON under the headlight lit state regardless of the steering operation or the turn signal operation performed by the driver.

After setting the irradiation mode to the “normal mode” in Step S13, the lighting ECU 10 terminates the tunnel irradiation assist control routine. The lighting ECU 10 repeats the processing described above in predetermined calculation periods. Then, when detecting that the own vehicle has entered the tunnel interval (Yes in Step S12), the lighting ECU 10 determines a lane in which the own vehicle is traveling. A road on which the own vehicle is traveling has a plurality of lanes. In Step S14, the lighting ECU 10 determines a positional relationship between the lane in which the own vehicle is traveling and another lane, that is, determines in which lane on the road the own vehicle is traveling.

In this case, the lighting ECU 10 may determine the lane in which the own vehicle is traveling based on the camera information, that is, information relating to the lanes determined by the image processing unit 42. Alternatively, the lighting ECU 10 may determine the lane in which the own vehicle is traveling from the position of the own vehicle and the map information based on the navigation information.

Subsequently, in Step S15, the lighting ECU 10 determines whether or not the lane in which the own vehicle is traveling is adjacent to any one of side walls of the tunnel. For example, when other lanes are positioned on both of the right and the left of the lane in which the own vehicle is traveling, it is determined that the lane in which the own vehicle is traveling is adjacent to none of the side walls of the tunnel. On the other hand, when another lane is positioned only on one of the right and the left of the lane in which the own vehicle is traveling, it is determined that the lane in which the own vehicle is traveling is adjacent to one of the side walls of the tunnel.

When the lighting ECU 10 determines that the traveling lane in which the own vehicle is traveling is adjacent to none one of the side walls of the tunnel (No in Step S15), the processing proceeds to Step S13 where the irradiation mode is set to the “normal mode”. On the other hand, when determining that the lane in which the own vehicle is traveling is adjacent to any one of the side walls of the tunnel (Yes in Step S15), the lighting ECU 10 determines a position direction of the side wall of the tunnel with respect to the own vehicle in Step S16. For example, when the another lane is detected only on the left side of the lane in which the own vehicle is traveling, it is determined that the side wall of the tunnel is positioned on the right side with respect to the own vehicle. When the another lane is detected only on the right side of the lane in which the own vehicle is traveling, it is determined that the side wall of the tunnel is positioned on the left side with respect to the own vehicle.

Therefore, the processing of determining the lane in which the own vehicle is traveling in Step S14 is processing of detecting a side-wall position direction indicating the position direction of the side wall of the tunnel, which is adjacent to the lane in which the own vehicle is traveling, with respect to the own vehicle.

When determining that the side wall of the tunnel is positioned on the right side with respect to the own vehicle, the lighting ECU 10 sets the irradiation mode to the “right irradiation support mode” in Step S17. On the other hand, when determining that the side wall of the tunnel is positioned on the left side with respect to the own vehicle, the lighting ECU 10 sets the irradiation mode to the “left irradiation support mode” in Step S18.

After setting the irradiation mode, the lighting ECU 10 terminates the tunnel irradiation assist control routine. The lighting ECU 10 repeats the above-mentioned processing in the predetermined calculation periods. Therefore, when the “right irradiation support mode” is set, the right cornering light 30R is selected from the left cornering light 30L and the right cornering light 30R under a state in which the headlights 20 are lit so that the selected right cornering light 30R is turned ON. Further, when the “left irradiation support mode” is set, the left cornering light 30L is selected from the left cornering light 30L and the right cornering light 30R under the state in which the headlights 20 are lit so that the selected left cornering light 30L is turned ON.

As a result, the headlights 20 are turned ON after the own vehicle enters the tunnel, the cornering light 30 provided on the positon direction of the side wall of the tunnel (hereinafter referred to as “side-wall side cornering light 30X”) is turned ON. The side-wall side cornering light 30X is continuously kept in the lit state in conjunction with the headlights 20 until the own vehicle exits the tunnel.

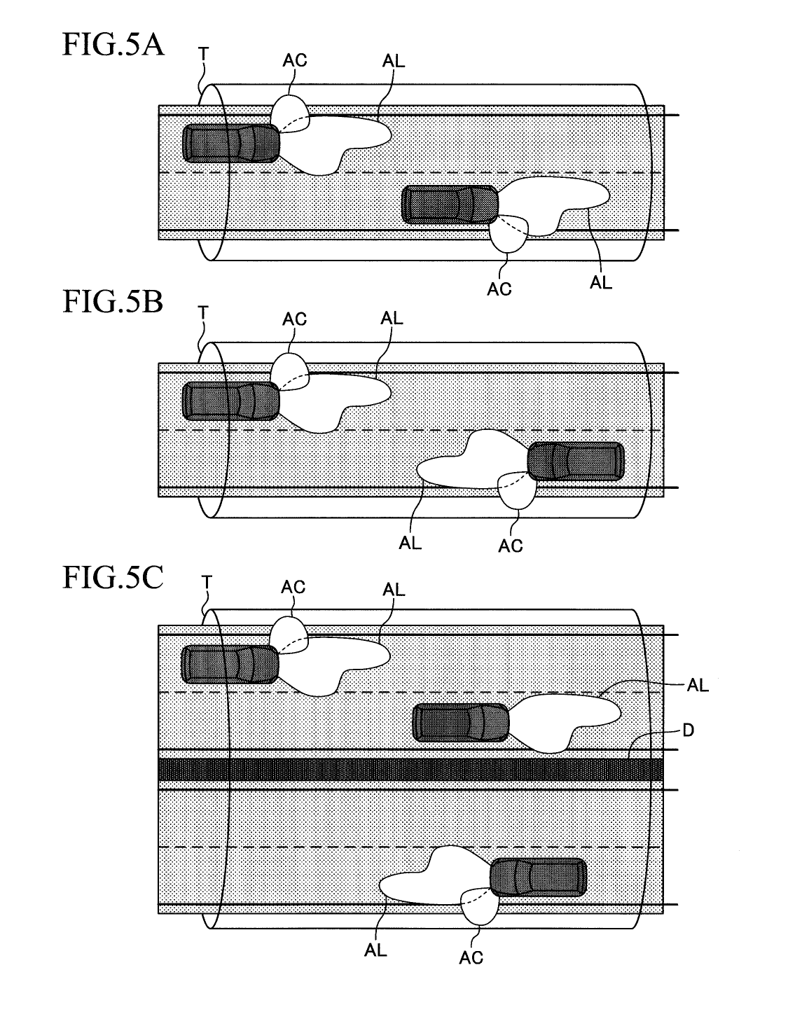

FIG. 5A, FIG. 5B, and FIG. 5C are views for illustrating images of a light irradiation state by the cornering lights 30 and the headlights 20 (low beam lights 21) during travel through a tunnel T. FIG. 5A is a view for illustrating a case where a road inside the tunnel T has two lanes in one direction, FIG. 5B is a view for illustrating a case where the road inside the tunnel T has one lane in each of opposite directions, and FIG. 5C is a view for illustrating a case where the road inside the tunnel T has two lanes in each of the opposite directions. In FIG. 5A to FIG. 5C, all the vehicles are illustrated as including the vehicular lighting apparatus 1 mounted therein. In FIG. 5A to FIG. 5C, an area AL is irradiated by the low beam lights 21 and an area AC is irradiated by the side-wall side cornering light 30X. The vehicular lighting apparatus 1 of the first embodiment is used in countries where vehicles should keep to the left. Therefore, the irradiation area AL irradiated by the low beam lights 21 contains a right-side area limited to a closer range as compared to a left-side area so as to prevent drivers of oncoming vehicles from being dazzled.

The side-wall side cornering light 30X irradiates a lateral area diagonally ahead of the own vehicle by being turned ON. Therefore, the irradiation area irradiated with light by the headlights 20 and the side-wall side cornering light 30X is larger toward the side-wall position direction of the tunnel than an irradiation area irradiated only by the headlights 20. In this manner, the side-wall cornering light 30X supports the headlights 20 in light irradiation so that the side wall of the tunnel is illuminated.

For example, in an example illustrated in FIG. 5A, the road inside the tunnel T has two lanes in one direction. Therefore, the left cornering light 30L is turned ON for the vehicle traveling in the left lane, whereas the right cornering light 30R is turned ON for the vehicle traveling in the right lane. In an example illustrated in FIG. 5B, the road inside the tunnel T has one lane in each of the opposite directions. Therefore, the left cornering light 30L is turned ON for the vehicles traveling in both of the lanes. Further, in an example illustrated in FIG. 5C, the road inside the tunnel T has two lanes in each of the opposite directions, which are separated from each other by a center divider D. Thus, the left cornering light 30L is turned ON only for the vehicle traveling in the left lane in each of the opposite directions, whereas none of the left cornering light 30L and the right cornering light 30R is turned ON for the vehicle traveling in the right lane in each of the opposite directions.

When the right cornering light 30R is turned ON, the right side wall of the tunnel T, which falls within a field of view of the driver, is illuminated. When the left cornering light 30L is turned ON, the left side wall of the tunnel T, which falls within the field of view of the driver, is illuminated.

According to the vehicular lighting apparatus of the first embodiment described above, during the travel through the tunnel, the side wall of the tunnel, which is adjacent to the own vehicle, is illuminated by the side-wall side cornering light 30X. As a result, the driver has increased ease of perceiving the distance between the side wall of the tunnel and the own vehicle, and therefore is less likely to have an oppressive feeling due to the side walls of the tunnel. Thus, anxiety given to the driver during the travel through the tunnel can be reduced. Further, the cornering light 30 on the side-wall position direction of the tunnel is selected to be turned ON, and thus the irradiation area does not expand toward another lane adjacent to the lane in which the own vehicle is traveling. Thus, a driver of another vehicle can be prevented from mistakenly perceiving a lane change by the own vehicle or having discomfort in driving.

Further, at the position before the entrance of the tunnel from which the own vehicle enters the tunnel, the “right irradiation support mode” or the “left irradiation support mode” is set. After the setting of the mode, the side-wall side cornering light 30X is turned ON in conjunction with the turn-ON of the headlights 20. Therefore, the turn-ON of the side-wall side cornering light 30X is not delayed from the turn-ON of the headlights 20.

The side wall of the tunnel can be irradiated by using the cornering lights 30 provided to the own vehicle. Thus, a dedicated light for irradiating the side walls of the tunnel is not required to be provided. Thus, the irradiation of the side walls of the tunnel can be achieved at low cost.

### MODIFICATION EXAMPLE 1

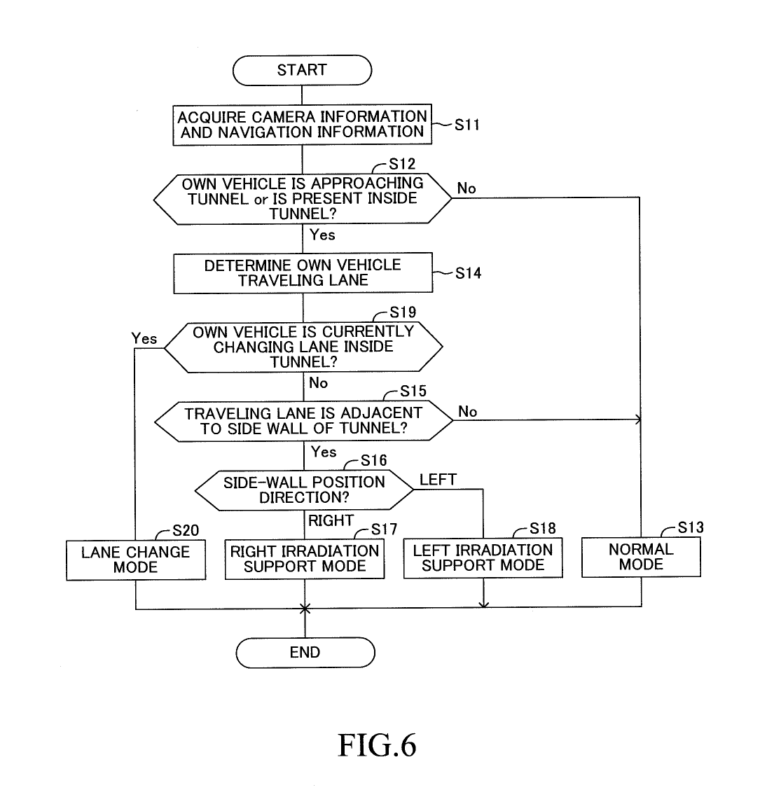

Next, Modification Example 1 of the first embodiment is described. In Modification Example 1, the lighting ECU 10 executes a tunnel irradiation assist control routine (Modification Example 1) illustrated in FIG. 6. The tunnel irradiation assist control routine (Modification Example 1) additionally includes processing in Step S19 and Step S20 in the tunnel irradiation assist control routine illustrated in FIG. 4 of the first embodiment described above, and therefore the remaining processing is the same as that of the tunnel irradiation assist control routine illustrated in FIG. 4 of the first embodiment. In the following, processing different from that of the tunnel irradiation assist control routine of the first embodiment is described.

After determining the lane in which the own vehicle is traveling in Step S14, the lighting ECU 10 determines whether or not the own vehicle is currently changing the lane inside the tunnel in Step S19. In this case, the lighting ECU 10 determines whether or not the own vehicle is changing the lane based on a lane change operation performed by the driver. For example, when the turn-signal signal is detected by the turn signal sensor 63, the lighting ECU 10 determines that the own vehicle is currently changing the lane. Alternatively, when detecting that the steering angle θ detected by the steering angle sensor 61 is equal to or larger than a lane change determination steering angle, the lighting ECU 10 determines that the own vehicle is currently changing the lane. The lane change determination steering angle may be changed so as to have a smaller value as the vehicle velocity V increases.

When the lighting ECU 10 determines that the own vehicle is not currently changing the lane (No in Step S19), the processing proceeds to Step S15 where the above-mentioned processing is performed. On the other hand, when the lighting ECU 10 determines that the own vehicle is currently changing the lane (Yes in Step S19), the processing proceeds to Step S20 where the irradiation mode is set to a “lane change mode”. Then, this routine is terminated.

In the “lane change mode”, the cornering light 30 provided to a direction of which the own vehicle is making a lane change is turned ON. For example, when the lane change operation in a right-hand direction is detected under a state in which the left cornering light 30L is lit, that is, a state in which the left irradiation support mode is set, the left cornering light 30L is turned OFF, whereas the right cornering light 30R is turned ON. Similarly, when the lane change operation in a left-hand direction is detected under a state in which the right cornering light 30R is lit, that is, a state in which the right irradiation support mode is set, the right cornering light 30R is turned OFF, whereas the left cornering light 30L is turned ON.

The lighting ECU 10 repeatedly executes this routine in the predetermined calculation periods. Therefore, after the lane change operation is not detected anymore, the “lane change mode” ends. Then, the irradiation mode that depends on the positional relationship between the lane in which the own vehicle is traveling and the side wall of the tunnel, which is adjacent to the own vehicle, is set.

Therefore, according to Modification Example 1, the driver can visually check the lane into which the own vehicle is making a lane change.

### Modification Example 2

Next, Modification Example 2 of the first embodiment is described. In Modification Example 2, the lighting ECU 10 is configured to turn ON both the left cornering light 30L and the right cornering light 30R only under a condition where another vehicle is not present in a periphery of the own vehicle during the travel through the tunnel. In Modification Example 2, the vehicular lighting apparatus 1 includes a camera device 40′ (see FIG. 1) configured to detect another vehicle that is present not only ahead of the own vehicle but also all around the own vehicle. The camera device 40′ supplies the camera information to the lighting ECU 10.

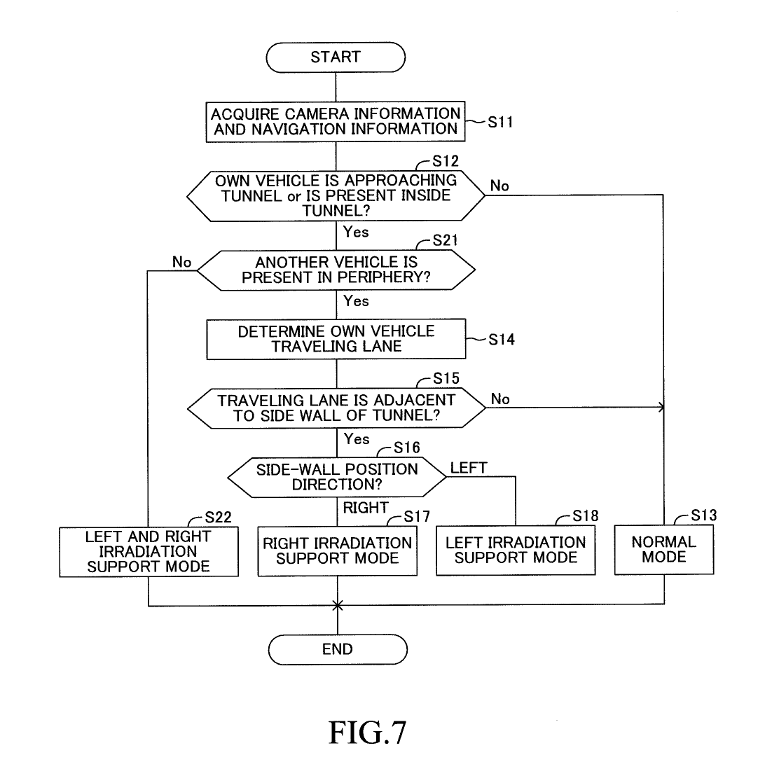

The lighting ECU 10 executes a tunnel irradiation assist control routine (Modification Example 2) illustrated in FIG. 7. The tunnel irradiation assist control routine (Modification Example 2) additionally includes processing in Step S21 and Step S22 in the tunnel irradiation assist control routine of the first embodiment illustrated in FIG. 4, and the remaining processing is the same as that of the tunnel irradiation assist control routine of the first embodiment illustrated in FIG. 4. In the following, processing different from that of the tunnel irradiation assist control routine of the first embodiment is described.

When the lighting ECU 10 detects that the own vehicle has entered the tunnel interval (Yes in Step S12), the processing proceeds to Step S21. In Step S21, the lighting ECU 10 determines whether or not another vehicle is present in the periphery, specifically, ahead, behind, on the left, or on the right of the own vehicle based on camera information output from the camera device 40′. When even one another vehicle is detected in the periphery of the own vehicle (Yes in Step S21), the processing from Step S14 described above is executed.

On the other hand, when no another vehicle is detected in the periphery of the own vehicle (No in Step S21), the lighting ECU 10 sets the irradiation mode to a “right and left irradiation support mode” in Step S22 and then terminates this routine. In the “right and left irradiation support mode”, the left cornering light 30L and the right cornering right 30R are turned ON under the headlight lit state regardless of the steering operation and the turn signal operation performed by the driver.

Therefore, according to Modification Example 2, when no another vehicle is present in the periphery of the own vehicle during the travel through the tunnel, both of the left cornering light 30L and the right cornering light 30R are turned ON to illuminate right and left areas diagonally ahead of the own vehicle. Therefore, visibility for both right and left sides within the field of view of the driver is improved. Thus, the own vehicle can travel further safely. Further, security feeling can be given to the driver. Further, discomfort is not given to the driver of another vehicle.

### Second Embodiment

Next, a vehicular lighting apparatus according to a second embodiment of the present invention is described. The vehicular lighting apparatus according to the second embodiment is a vehicular lighting apparatus in which an Adaptive High beam System (AHS) is mounted. The Adaptive High beam System (hereinafter referred to as “AHS”) is a system capable of freely controlling an irradiation area (light distribution area) irradiated by the high beam lights among the low beam lights and the high beam lights provided as the headlights.

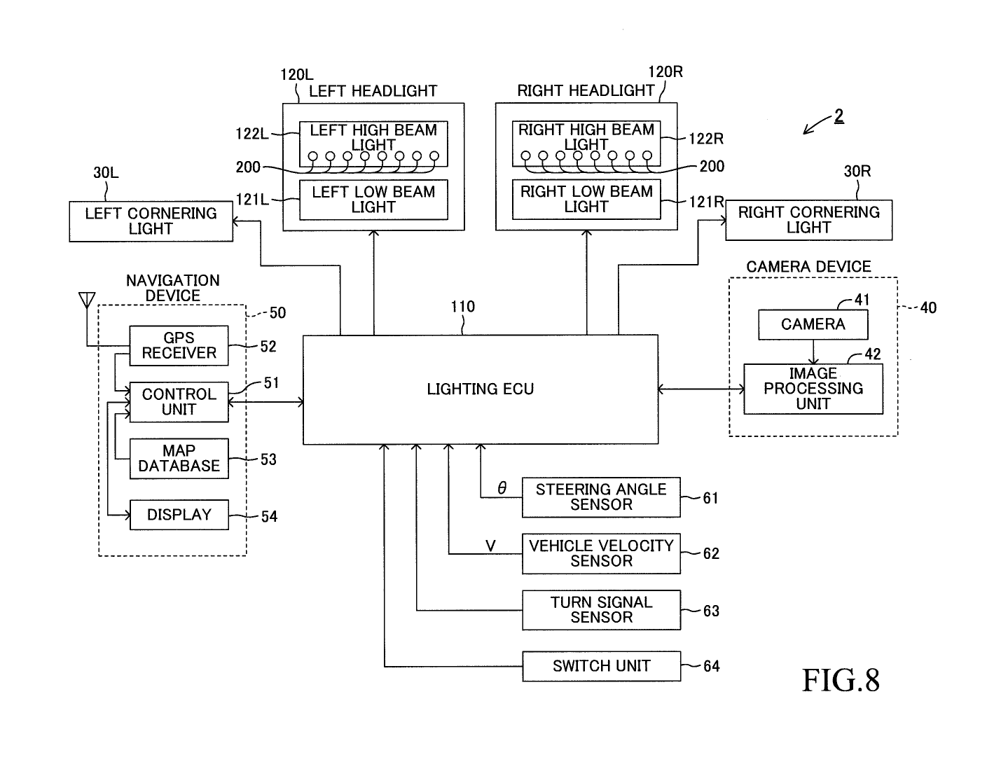

In FIG. 8, a schematic configuration of a vehicular lighting apparatus 2 according to the second embodiment is illustrated. The vehicular lighting apparatus 2 includes a lighting ECU 110, a left headlight 120L, a right headlight 120R, the left cornering light 30L, the right cornering light 30R, the camera device 40, the navigation device 50, the steering angle sensor 61, the vehicle velocity sensor 62, the turn signal sensor 63, and the switch unit 64. The same components as those of the vehicular lighting apparatus 1 of the first embodiment are denoted by the same reference symbols of the vehicular lighting apparatus 1 in FIG. 8, and description thereof is herein omitted. Further, the vehicular lighting apparatus 2 does not use the cornering lights 30 to execute tunnel irradiation assist control described later, and therefore is not required to include the cornering lights 30.

The left headlight 120L and the right headlight 120R are headlights using the AHS, and are provided to the front end of the vehicle so as to be bilaterally symmetric as illustrated in FIG. 8. The left headlight 120L and the right headlight 120R have the same basic configuration. The left headlight 120L includes a left low beam light 121L and a left high beam light 122L. The right headlight 120R includes a right low beam light 121R and a right high beam light 122R. When the left headlight 120L and the right headlight 120R are not required to be distinguished from each other, the left headlight 120L and the right headlight 120R are hereinafter referred to collectively as “headlights 120”. Further, when the left low beam light 121L and the right low beam light 121R are not required to be distinguished from each other, the left low beam light 121L and the right low beam light 121R are referred to collectively as “low beam lights 121”. When the left high beam light 122L and the right high beam light 122R are not required to be distinguished from each other, the left high beam light 122L and the right high beam light 122R are referred to collectively as “high beam lights 122”. The low beam lights 121 and the high beam lights 122 are connected to the lighting ECU 110, and are controlled to be turned ON by the lighting ECU 110.

Of the low beam lights 121 and the high beam lights 122 of the headlights 120, the high beam lights 122 are of variable light distribution type, specifically, are capable of controlling light distributions. The low beam lights 121 do not perform the light distribution control, and may therefore be the same as the low beam lights 21 used in the first embodiment. Each of the high beam lights 122 is formed by arranging a plurality of LED light sources (light-emitting diodes) 200 in a horizontal row. Arrangement of the LED light sources 200 may be arbitrarily set. For example, the LED light sources 200 may be arranged in a plurality of rows. Further, the number of LED light sources 200 included in each of the high beam lights 122 may be arbitrarily set. The LED light sources 200 are hereinafter simply referred to as “LEDs 200”.

The lighting ECU 110 is different from the lighting ECU 10 of the first embodiment in that a function of controlling the light distributions of the high beam lights 122 is additionally provided and tunnel irradiation assist control using the high beam lights 122 described later is performed. The remaining functions of the lighting ECU 110 are the same as those of the lighting ECU 10 of the first embodiment.

The plurality of LEDs 200 included in each of the high beam lights 122 are connected to the lighting ECU 110 independently of each other, and are selectively turned ON by the lighting ECU 110. Further, a current to flow through each of the LEDs 200 is individually controlled by the lighting ECU 110 so that a quantity of light emitted from each of the LEDs is controllable. Irradiation directions of the LEDs 200 are determined so as to be different from each other. Through turn-ON of all the LEDs 200, the entire illumination area to be irradiated by the high beam lights 122 can be irradiated with light. In other words, through turn-ON of only arbitrary ones of the LEDs 200, only an irradiation area to be irradiated by the turned-ON LEDs 200, that is, only a part of the entire irradiation area to be irradiated by the high beam lights 122 can be irradiated with light.

The low beam lights 121 correspond to headlights for low beams being a main irradiation unit of the present invention, whereas the high beam lights 122 correspond to headlights for high beams being an support irradiation unit of the present invention. Therefore, the headlights 120 including the low beam lights 121 and the high beam lights 122 correspond to an irradiator of the present invention.

Light irradiation by each of the LEDs 200 is hereinafter also referred to as “high beam light distribution”, and an area irradiated by each of the LEDs 200 is hereinafter also referred to as “high beam light distribution area”.

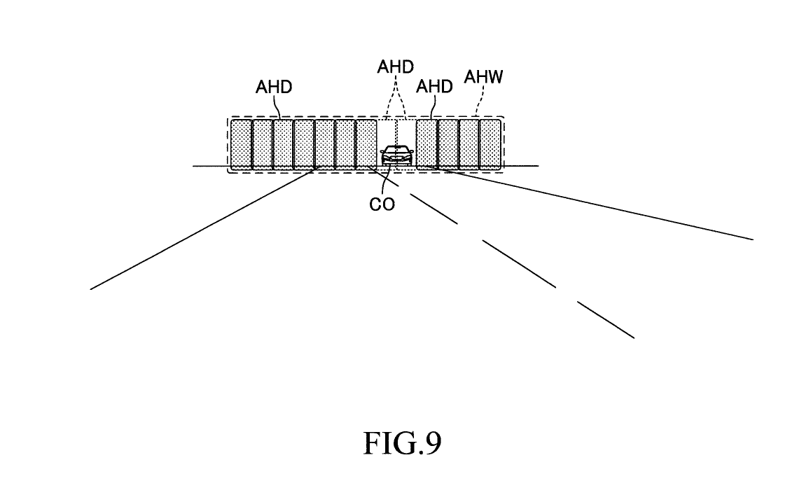

The high beam light distribution area is set to a far side (upper side) of each of the irradiation areas by the low beam lights 121. As illustrated in FIG. 9, the lighting with the high beam distribution is achieved by dividing a preset overall high beam irradiation area AHW into a plurality (the number of the LEDs 200) of areas in a horizontal direction (vehicle width direction) so that each of divided high beam areas AHD being areas formed by the division is set as a light distribution area for each of the LEDs 200. Therefore, in accordance with conditions in the periphery of the own vehicle, only arbitrary one of the divided high beam areas AHD can be unilluminated. For example, only the divided high beam areas AHDs in which an oncoming vehicle CO is detected can be unilluminated, as illustrated in FIG. 9.

For example, when the Hi/Lo selector switch is set to Hi, the lighting ECU 110 turns ON the high beam lights 122 in addition to the low beam lights 121. When the preceding vehicle or the oncoming vehicle is detected by the camera device 40, however, the LED 200 in charge of the light distribution to the divided high beam area AHD corresponding to an area containing the vehicle is turned OFF. In this manner, the driver of the preceding vehicle or the oncoming vehicle can be prevented from being dazzled.

There is widely known a technology of making up each of the high beam lights 122 of the plurality of LEDs 200 and independently controlling turn-ON/OFF of each of the LEDs 200 in accordance with the conditions in the periphery of the own vehicle as described above. Thus, for example, technologies disclosed in Japanese Patent Application Laid-open No. 2009-123566, Japanese Patent Application Laid-open No. 2008-37240, and Japanese Patent Application Laid-open No. 2008-114800 can be employed.

Further, the lighting ECU 110 controls the high beam light distribution areas in accordance with the vehicle velocity V detected by the vehicle velocity sensor 62. For example, when the vehicle velocity V falls within a low-velocity area, the lighting ECU 110 sets the high beam light distribution areas so that an area extending in a vehicle width direction is irradiated with light. When the vehicle velocity V falls within a high-velocity area, the lighting ECU 110 sets the high beam light distribution areas so that an area limited to a central side in the vehicle width direction is irradiated with light. Therefore, during travel at a high speed, the LEDs 200 in charge of irradiation of both of a left area and a right area in the vehicle width direction, which are contained in the overall high beam irradiation area AHW, are not turned ON, or light quantities of the LEDs 200 are reduced.

Next, tunnel irradiation assist control executed by the lighting ECU 110 is described. The lighting ECU 110 executes the tunnel irradiation assist control routine, which is described in the first embodiment and illustrated in FIG. 4. In this case, contents of the irradiation modes are different from those of the first embodiment.

The lighting ECU 110 controls turn-ON of the headlights 120 in accordance with the irradiation mode under a condition in which a turn-ON request for the headlights 120 is output by the lighting switch, that is, under the lighting switch ON state.

When the irradiation mode is set to the “normal mode” (Step S13), the low beam lights 121 are turned ON under a condition in which the Hi/Lo selector switch is set to Lo. The high beam lights 122 are turned ON in addition to the low beam lights 121 under a condition in which the Hi/Low selector switch is set to Hi. As described above, when the high beam lights 122 are turned ON, the lighting ECU 110 controls the high beam light distribution areas in accordance with the presence/absence of the preceding vehicle, the presence/absence of the oncoming vehicle, and the vehicle velocity V.

On the other hand, when the irradiation mode is set to the “right irradiation support mode” (Step S17) and the irradiation mode is set to the “left irradiation support mode” (Step S18), the following light distribution control is additionally performed for the high beam light 122 on a side closer to the side wall of the tunnel in addition to the light distribution control for the high beam lights 122 in the “normal mode” described above.

For example, when the side wall of the tunnel is positioned on the right side of the own vehicle, the irradiation mode is set to the “right irradiation support mode”. In this case, the lighting ECU 110 controls the right high beam light 122R of the right headlight 120R to irradiate the right high beam light distribution area, that is, the right area in the overall high beam irradiation area AHW with light regardless of setting of the Hi/Lo selector switch. Specifically, the LEDs 200 that irradiate the right high beam light distribution area for the right high beam light 122R with light are selected. The selected LEDs 200 are energized to irradiate the right high beam light distribution area with light. The right high beam light distribution area is set so that the side wall of the tunnel, which is positioned on the right side of the own vehicle, can be irradiated.

Further, for example, when the side wall of the tunnel is positioned on the left side of the own vehicle, the irradiation mode is set to the “left irradiation support mode”. In this case, the lighting ECU 110 controls the left high beam light 122L of the left headlight 120L to irradiate the left high beam light distribution area, that is, the left area in the overall high beam irradiation area AHW with light regardless of setting of the Hi/Lo selector switch. Specifically, the LEDs 200 that irradiate the left high beam light distribution area for the left high beam light 122L with light are selected. The selected LEDs 200 are energized to irradiate the left high beam light distribution area with light. The left high beam light distribution area is set so that the side wall of the tunnel, which is positioned on the left side of the own vehicle, can be irradiated.

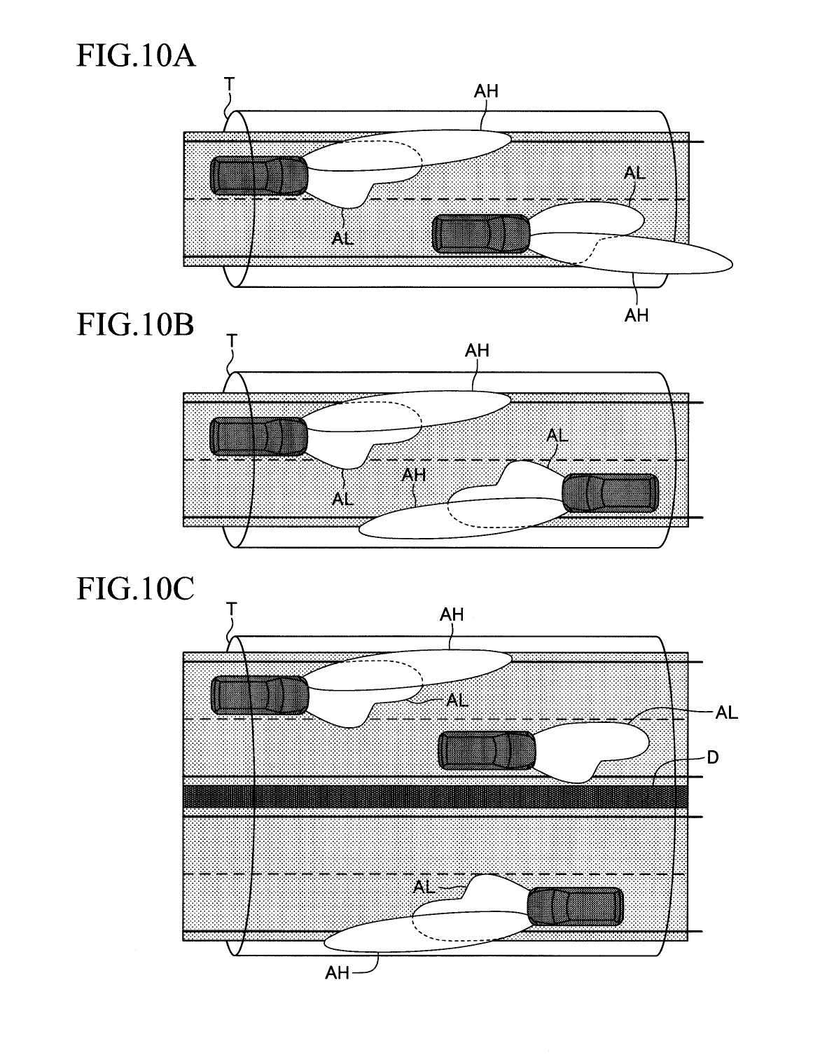

FIG. 10A, FIG. 10B, and FIG. 10C are views for illustrating images of a light irradiation state by the low beam lights 121 and the high beam lights 122 during travel through the tunnel T. FIG. 10A is a view for illustrating the case where the road inside the tunnel T has two lanes in one direction, FIG. 10B is a view for illustrating the case where the road inside the tunnel T has one lane in each of the opposite directions, and FIG. 10C is a view for illustrating the case where the road inside the tunnel T has two lanes in each of the opposite directions. In FIG. 10A to FIG. 10C, all the vehicles are illustrated as including the vehicular lighting apparatus 2 of the second embodiment mounted therein. In FIG. 10A to FIG. 10C, the area AL is irradiated by the low beam lights 121 and an area AH is irradiated by the high beam lights 122.

The LED 200 configured to radiate light when the irradiation mode is set to the “left irradiation support mode” or the “right irradiation support mode” is referred to as an “support LED 200X”.

The support LED 200X irradiates the lateral area diagonally ahead of the own vehicle by being turned ON. Therefore, the irradiation area irradiated with light by the low beam lights 121 and the support LED 200X expands to an upper side and a far side toward the side-wall position direction of the side wall of the tunnel as compared to the irradiation area irradiated only by the low beam lights 121. In this manner, the support LED 200X supports the low beam lights 121 in light irradiation so that the side wall of the tunnel is illuminated.

For example, in an example illustrated in FIG. 10A, the road inside the tunnel has two lanes in one direction. Therefore, the support LED 200X of the left high beam light 122L is turned ON for the vehicle traveling in the left lane, whereas the support LED 200X of the right high beam light 122R is turned ON for the vehicle traveling in the right lane. In an example illustrated in FIG. 10B, the road inside the tunnel has one lane in each of the opposite directions. Therefore, the support LED 200X of the left high beam light 122L is turned ON for the vehicles traveling in both of the lanes. Further, in an example illustrated in FIG. 10C, the road inside the tunnel has two lanes in each of the opposite directions, which are separated from each other by the center divider D. Thus, the support LED 200X of the left high beam light 122L is turned ON only for the vehicle traveling in the left lane in each of the opposite directions, whereas none of the left high beam light 122L and the right high beam light 122R is turned ON for the vehicle traveling in the right lane in each of the opposite directions.

When the support LED 200X of the right high beam light 122R is turned ON, the right side wall of the tunnel, which falls within a field of view of the driver, is illuminated. When the support LED 200X of the left high beam light 122L is turned ON, the left side wall of the tunnel, which falls within the field of view of the driver, is illuminated.

According to the vehicular lighting apparatus 2 of the second embodiment described above, the side wall of the tunnel, which is adjacent to the own vehicle, is illuminated by the support LED 200X of the high beam lights 122. As a result, the driver has increased ease of perceiving the distance between the side wall of the tunnel and the own vehicle, and therefore is less likely to have an oppressive feeling due to the side walls of the tunnel. Thus, anxiety given to the driver during the travel through the tunnel can be reduced. Further, the support LED 200X configured to irradiate the high beam light distribution area on a side closer to the side wall of the tunnel with light is selected to be turned ON. Thus, the irradiation area does not expand toward another lane adjacent to the lane in which the own vehicle is traveling. Therefore, a driver of another vehicle can be prevented from mistakenly perceiving a lane change by the own vehicle or having discomfort in driving.

Further, the “right irradiation support mode” or the “left irradiation support mode” is set at a position before the entrance of the tunnel from which the own vehicle enters the tunnel, and the support LED 200X of the high beam lights 122 is turned ON in conjunction with turn-ON of the low beam lights 121. Therefore, the turn-ON of the support LED 200X is not delayed from the turn-ON of the low beam lights 121.

Further, tunnels are frequently built on highways. Therefore, the vehicle travels through the tunnel at a high speed in many cases. During the high-speed traveling, the high beam light distribution area is limited to the center side in the vehicle width direction as described above, and therefore the side walls of the tunnel look dark. According to the second embodiment, however, the problem described above can be effectively solved.

The side wall of the tunnel can be irradiated by using the variable light distribution high beam lights 122 provided to the own vehicle. As a result, according to one embodiment of the present invention, a dedicated light for irradiating the side walls of the tunnel is not required to be provided. Thus, the irradiation of the side walls of the tunnel can be achieved at low cost.

In the above, the vehicular lighting apparatus 1 and 2 according to the first embodiment and the second embodiment have been described, but the present invention is not limited to the above-mentioned embodiments, and various changes are possible within the range not departing from the object of the present invention.

For example, in order to illuminate the side walls of the tunnel, the existing cornering lights 30 are used in the first embodiment, whereas the existing variable light distribution high beam lights 122 are used in the second embodiment. However, the lights described above are not required to be used, and other existing lights may be used. Alternatively, new support lights may be provided.

Further, although the cornering lights 30 are provided independently of the headlights 20 (120) in the first embodiment and the second embodiment, each of the cornering lights 30 may be provided in a casing of a corresponding one of the headlights 20 (120).

Further, although the plurality of LEDs are included in each of the variable light distribution high beam lights and the high beam light distribution area is controlled by controlling the turn-ON/OFF of each of the LEDs in the second embodiment, the high beam light distribution area may be controlled by, for example, providing a shading mechanism to each of the high beam lights so that a part of the irradiation area irradiated by the high beam light is shielded by the shading mechanism. As the shading mechanism, a shading mechanism disclosed in, for example, Japanese Patent Application Laid-open No. 2014-51191 can be used.

Further, in the first embodiment and the second embodiment, the lane in which the own vehicle is traveling is continuously determined while the own vehicle is present in the interval from the position before the entrance of the tunnel to the position of the exit of the tunnel (Step S14). However, the determination of the lane after the own vehicle enters the tunnel may be omitted on the assumption that, during the travel through the tunnel, the own vehicle still continuously travels in the traveling lane that is detected immediately before the own vehicle enters the tunnel.

Still further, although the high beam light 122 provided on the side-wall position direction of the tunnel is selected and the selected high beam light 122 is controlled so that the light distribution area of the plurality of light distribution areas, which is positioned on the side-wall position direction of the tunnel, is irradiated with light, both of the left high beam light 122L and the right high beam light 122R may be controlled so that the light distribution area, which is positioned on the side-wall position direction of the tunnel, is irradiated with light.

Still further, in the second embodiment, for example, only when the Hi/Lo selector switch is set to Lo (low beam), the “left irradiation support mode” and the “right irradiation support mode” may be selectable as the irradiation mode.

What is claimed is:

1. A vehicular lighting apparatus, comprising:
an irradiator comprising:
a main irradiation unit for radiating light ahead of an own vehicle; and
a support irradiation unit for supporting the main irradiation unit in the radiation of the light;
side-wall position direction detecting means for detecting a side-wall position direction indicating a position direction of a side wall of a tunnel, which is adjacent to a lane in which the own vehicle is traveling, with respect to the own vehicle while the own vehicle is traveling through the tunnel; and
side-wall irradiation control means for setting, when the side wall of the tunnel is positioned adjacent to the lane in which the own vehicle is traveling, a direction of the radiation of the light by the support irradiation unit, based on the side-wall position direction, so that an irradiation area irradiated by the irradiator becomes larger on a side of the side-wall position direction than an irradiation area irradiated by the main irradiation unit and controlling the support irradiation unit to radiate the light.

2. The vehicular lighting apparatus according to claim 1,
wherein the support irradiation unit comprises a variable light distribution light capable of controlling the radiation of the light for each of a plurality of light distribution areas obtained by dividing an irradiation area ahead of the own vehicle in a vehicle width direction, and
wherein the side-wall irradiation control means is configured to select a light distribution area positioned on the side-wall position direction from the plurality of divided light distribution areas and control the variable light distribution light so that the selected light distribution area is irradiated with the light.

3. The vehicular lighting apparatus according to claim 2,
wherein the main irradiation unit comprises a headlight for low beam, for radiating the light ahead of the own vehicle, and
wherein the support irradiation unit comprises a headlight for high beam, which uses the variable light distribution light.

4. The vehicular lighting apparatus according to claim 1,
wherein the main irradiation unit comprises a headlight for radiating the light ahead of the own vehicle,
wherein the support irradiation unit comprises a left support light, which is provided to a left side of the own vehicle, for radiating light to a diagonally left side ahead of the own vehicle, and a right support light, which is provided to a right side of the own vehicle, for radiating light to a diagonally right side ahead of the own vehicle, and
wherein the side-wall irradiation control means is configured to select and turn ON one of the left support light and the right support light, which is provided on the side-wall position direction.

5. The vehicular lighting apparatus according to claim 4,
wherein the left support light comprises a left cornering light to be turned ON when the own vehicle is steered to left, and
wherein the right support light comprises a right cornering light to be turned ON when the own vehicle is steered to right.

6. The vehicular lighting apparatus according to claim 4, further comprising lane change means for detecting a lane change operation performed by a driver while the own vehicle is traveling through the tunnel,
wherein the side-wall irradiation control means is configured to, when the lane change operation is detected, turn OFF the one of the left support light and the right support light, which is provided on the side-wall position direction, and turn ON another of the left support light and the right support light provided on a direction of which the own vehicle is making a lane change.

7. The vehicular lighting apparatus according to claim 4, further comprising another vehicle detecting means for detecting another vehicle being present in a periphery of the own vehicle,
wherein the side-wall irradiation control means is configured to turn ON both the left support light and the right support light when the another vehicle is not detected in the periphery of the own vehicle.

8. The vehicular lighting apparatus according to claim 1, wherein the side-wall position direction detecting means is configured to specify a lane of a plurality of lanes on a road, in which the own vehicle is traveling, and to detect the side-wall position direction based on the specified lane.
